(19) United States
(12) Patent Application Publication
(10) Pub. No.: US 2024/0273172 A1
(43) Pub. Date: Aug. 15, 2024

(54) DEVICE-AGNOSTIC USER AUTHENTICATION AND TOKEN PROVISIONING

(71) Applicant: IMPRIVATA, INC., Lexington, MA (US)

(72) Inventor: Matt ERICH, Burlington, MA (US)

(21) Appl. No.: 18/621,832

(22) Filed: Mar. 29, 2024

Related U.S. Application Data
(63) Continuation-in-part of application No. 15/679,343, filed on Aug. 17, 2017, now abandoned.
(60) Provisional application No. 62/380,647, filed on Aug. 29, 2016.

(51) Int. Cl. G06F 21/31

(52) U.S. Cl. CPC G06F 21/31

(57) ABSTRACT

In various embodiments, the user of a client device that executes a remote application is authenticated by first receiving an HTTP or HTTPS request to authenticate the user from the remote application. The user is prompted for authentication information, and authentication information is obtained by communicating with a hardware device in electronic communication with the client device. The user's authorization to use the remote application is then verified using a computer processor and using the authentication information. Once the user is authenticated, embodiments of the invention use the authentication to program an authentication token for the user.

### RELATED APPLICATIONS

This application claims priority to and is a continuation-in-part of U.S. patent application Ser. No. 15/679,343, filed Aug. 17, 2017, which claims the benefit of and priority to U.S. Provisional Patent Application No. 62/380,647, filed Aug. 29, 2016, each disclosure of which is hereby incorporated by reference in its entirety.

### TECHNICAL FIELD

Embodiments of the present invention relate generally to authentication and provisioning, more specifically, to remote authentication and provisioning.

### BACKGROUND

Remote or externally hosted applications, such as web-based applications, may be deployed and executed on local client devices via the use of web browsers or other local client software. Frequently, a user of the client device is required to authenticate himself or herself before using the remote application in accordance with the security policy of the organization, company, or network of which the user is a member, the security policy of the remote application provider, or other security policy. This authentication may include supplying a username and password, interacting with a biometric scanner (e.g., a fingerprint reader), and/or authentication in some other manner Authentication is particularly stringent for applications involving the exchange of sensitive or confidential information.

In conventional systems, the remote application typically collects authentication information. In the case of a username/password process, the remote application may, for example, present a dialog box prompting the user for this information and verify the received username and password against a secure list. In the case of device-based authentication (e.g., a fingerprint reader), the remote application includes software to interact with and operate the device (to, e.g., activate it, receive the scanned user fingerprint data, and either verify the received fingerprint data against known fingerprint data or transmit it to an authentication server). Often, for security reasons, the software used to interact with the hardware device is a browser plug-in.

Security policies may vary greatly depending on the nature of the application and the policies of an organization; some may require only a username/password, while others require the use of hardware authentication devices. The latter policy can be difficult to implement, particularly from the perspective of designing the remote application, given the wide variety of hardware authentication devices that the remote application would have to support. This is further complicated by the fact that the remote application may itself be executed by different platforms (e.g., browser types and versions), which may behave differently when interacting with an external device.

The difficulty in designing and maintaining these capabilities may create operability problems, bugs, or security holes in the use of the remote application on the local client, in particular when the remote application attempts to control a local resource in order to, for example, facilitate user authentication. A need therefore exists for a simpler and more secure approach to for managing secure access to remote applications when the remote application interacts with local resources.

### SUMMARY

Embodiments of the present invention include an authentication-request handler, local to a client device (rather than, for example, hosted with remote applications requiring authentication or on other remote servers such as remote authentication servers), which executes instructions for collecting authentication information from a user of the device. For example, the authentication-request handler may operate a hardware device (such as a biometric scanner, proximity card reader, or smart card reader) that actually gathers the information from the user. The authentication-request handler may pass the information to the client device, which itself uses the information for authentication purposes—e.g., transmitting the information to the host of a remote application to which the user seeks access or to an authentication server, or may instead authenticate the user locally, e.g., by verifying the authentication information against a local or remote authentication database.

Once the user is authenticated, embodiments of the invention use the authentication to program an authentication token for the user. This token may, in some instances, relieve the user of the need to authenticate using the hardware device or at least simplify the authentication. For example, the user may initially authenticate with a palm reader, following which an RFID tag is programmed for the user. Depending on the security policy associated with the remote application (and perhaps the user's permission level), presenting the RFID tag may suffice to give the user access to the application the next time he seeks it. More generally, the token may be used for any authentication or identification purpose, though these frequently involve physical access and/or access to devices. For example, similar tokens may be issued to all employees of the institution, and generating or programming it in the context of an activity the user is already undertaking spares her the need to obtain it in a separate registration procedure.

Thus, embodiments of the invention issue tokens to users (1) enabling access to various secure resources and (2) after an incidental authentication for use of an unrelated resource or remote application. The authentication-request handler and the hardware device utilized to authenticate the user may therefore not be token programmers themselves—i.e., the handler and device may be unrelated to and/or incapable of issuing or programming tokens, or, at a minimum, the handler and device may not be utilized for token generation in response to the initial user authentication. However, the user's authentication may advantageously be utilized to trigger the issuing of tokens related to additional, different secure resources without requiring the user to complete any separate or additional authentication process related to the token or its generation. The token may related to, and/or be issued on the basis of, stored authorization data that is not necessarily acquired during the authentication process or information initially supplied by the user. Moreover, once the token is generated and issued to the user, the user may utilize the token to access one or more secure resources other than the resource or application for which the initial authentication information was supplied, and use of the token may supplement or replace the need to perform any separate related authentication procedure.

Embodiments of the invention may be utilized to authenticate and provision tokens to users having or requiring authorization to utilize and/or access a wide variety of different secure resources and in accordance with different security policies. For example, in the healthcare context, users as described herein may be healthcare providers such as doctors, other clinicians, or administrative officials, and may also be patients. A doctor may, for example, be authenticated when requesting access to an electronic record system or other healthcare management application, and, after successful authentication, may be issued a token enabling subsequent access to other applications or patient files. An administrator may be issued a token granting a different level of access corresponding to authorization data related to the administrator's identity and/or job function, as specified in the institution's security policy; for example, an administrator may have access to patient files associated with multiple (or even all) doctors and/or secure locations (e.g., server rooms, etc.) to which doctors are not granted access. Patients, once successfully authenticated (e.g., during a registration process for access of their electronic records), may be issued tokens that enable access to, e.g., a particular ward or other location to which they have been assigned, electronic prescription information or test results, and other information specified for the patient by a responsible clinician. For example, a token is issued to a patient after she is authenticated by a registration system, and the token is usable to enable different secure resources such as particular physical locations. Like an access to a secure website or computerized system, once the registration process is complete and the user leaves to, for example, access another physical location, that registration routine ends and the accompanying authentication expires. In addition, the incidentally issued token continues to function and provides access to other resources.

In another example, the registration of a patient at a particular hospital, clinic, or ward (or part thereof) may be streamlined via use of the token issued to the patient; the registration system may be aware of the patient's identity (and/or other data or characteristics) since the patient's identity and/or authorization was confirmed by the initial authorization process (e.g., during an initial enrollment process), and the token may be presented to complete or fulfill such a registration process. The authorization information associated with certain users may be changed or updated by other users having additional security privileges. For example, a patient's doctor or other healthcare provider may update or change a patient's token-based authorization if, e.g., the patient requires access to a different part of a hospital or additional patient-specific information.

In an aspect, embodiments of the invention feature a system for enabling user access to secure resources in conjunction with authentication of the user on a client device executing a remote application. The system includes, consists essentially of, or consists of a database of authentication data, a database of authorization information, and a client device. The database of authentication data and the database of authorization information may be discrete and separate databases (e.g., hosted on different servers and/or on different portions of a network). The database of authentication data and the database of authorization information may be portions of a single database and/or may be hosted on the same server and on the same portion of a network. The client device includes, consists essentially of, or consists of a network interface, a computer processor for executing software instructions of a remote application, an authorization-request handler executable by the computer processor, and a token-generation module executable by the computer processor. The authorization-request handler is configured to (a) electronically receive a request to authenticate the user from the remote application, the remote application being an application other than a token programmer, (b) prompt the user for authentication information in a manner consistent with the request, (c) communicate with a hardware device in electronic communication with the client device to obtain the authentication information, and (d) cause the authentication information to be compared to authentication data in the database of authentication data to verify that the user is authorized to use the remote application (i.e., authorize the user to use the remote application). The token-generation module is configured to (e.g., only after the user is authorized to use the remote application) (A) electronically receive, from the database of authorization information, authorization information for the user related to one or more secure resources other than the remote application, and (B) cause a token programmer to program a token for the user consistent with the authorization information without requiring additional authentication of the user by the token programmer

Embodiments of the invention may include one or more of the following in any of a variety of combinations. The system may include a remote host for hosting the remote application and/or comparing the authentication information to the database of authentication data. The system may include an authorization server for comparing the authentication information to the database of authentication data. The authorization server may not host the remote application. The token programmer may be configured to program a smart card, an RFID tag, and/or a soft token. The authorization information may specify physical access restrictions for the user and/or electronic access restrictions for the user. The system may include an authorization server for managing the database of authorization information and returning user information therefrom in response to a request from the client.

In another aspect, embodiments of the invention feature a method for authenticating a user of a client device executing a remote application, and, in conjunction therewith, enabling access for the user to secure resources. A request (e.g., an HTTP or HTTPS request) to authenticate the user is electronically received from the remote application with an authentication-request handler local to the client device. The remote application may be an application other than a token programmer The user is prompted for authentication information. The handler is used to communicate with a hardware device in electronic communication with the client device to obtain the authentication information. It is verified, using a computer processor and the authentication information, that the user is authorized to use the remote application. Authorization information for the user related to one or more secure resources other than the remote application is received. The authorization information may only be received after the user is authorized to use the remote application. Thereafter, a token is programmed for the user consistent with the authorization information without requiring additional authentication of the user.

Embodiments of the invention may include one or more of the following in any of a variety of combinations. The step of verifying may be performed by the remote application. The step of verifying may be performed by an authorization server. The step of verifying may include electronically sending, to the remote application, a message (e.g., an HTTP or HTTPS message) confirming authentication of the user. The token may include, consist essentially of, or consist of a smart card, an RFID tag, and/or a soft token. The authorization information may specify physical access restrictions for the user and/or electronic access restrictions for the user.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a system for authentication in accordance with embodiments of the present invention;

FIG. 2 is a flowchart of an authentication process in accordance with embodiments of the present invention; and

FIG. 3 is a flowchart of another authentication process in accordance with embodiments of the present invention.

### DETAILED DESCRIPTION

An authentication-request handler, running on a client device, executes instructions for collecting authentication information from a user of the device. An authentication request may be triggered by a user (by, for example, opening an application or selecting a “log in” button or link), by the application (if, for example, a certain amount of wall-clock time or user idle time has elapsed), and/or by other means (such as, for example, by monitoring the proximity of the user or others to the client device). If and when authentication is required, the application or server sends a request to the authentication-request handler and awaits a response.

The authentication-request handler receives the request and collects the information via username/password entry (e.g., by generating an on-screen window with a prompt) and/or a hardware authentication device. Once the information is collected, the authentication-request handler sends it to the remote application or to an authentication server. Thus, the authentication-request handler permits the remote application to authenticate a user without directly interacting with local hardware. As a result, the remote application need not direct or even “know” exactly how authentication information is collected; so long as the information it receives conforms to the request and is verified and obtained via a modality consistent with a security policy (if any) that it implements, the mechanics of collecting authentication information is left to functionality executing on the client. This, in turn, makes the remote application compatible with a broad range of clients having varying capabilities and hardware resources without sacrificing security. Following successful authentication, a token is provisioned for the user for use in, e.g., subsequent authentications and/or for accessing other secure resources (e.g., other remote applications, confidential data, physical locations, etc.).

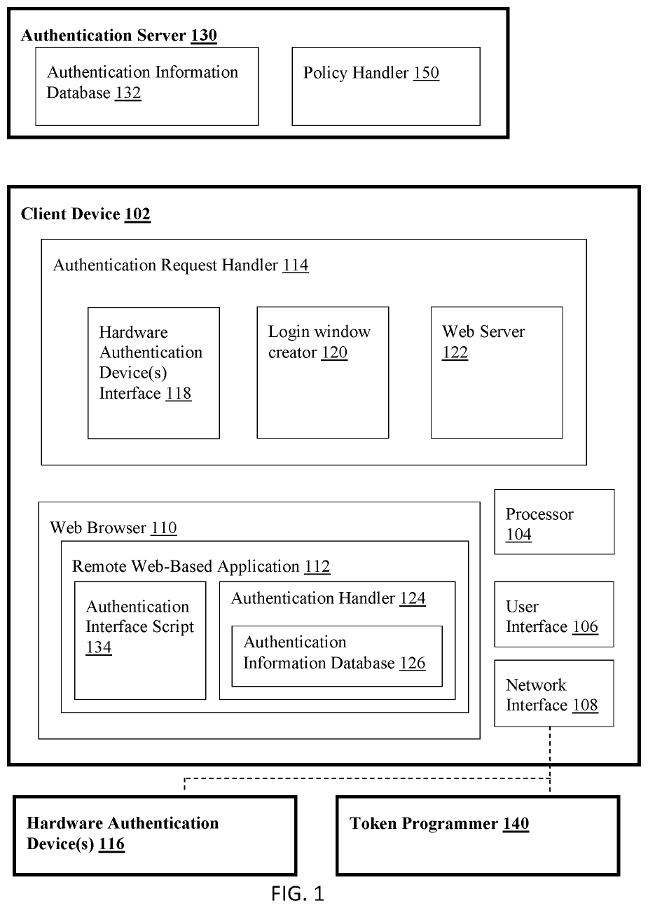

FIG. 1 illustrates a client device 102 in accordance with embodiments of the present invention. The client device 102 may be a desktop computer, laptop or portable computer, tablet computer, smartphone, or any other type of similar device and includes a computer memory (e.g., RAM) for storing instructions and data, a processor 104 (e.g., INTEL XEON) for executing instructions, a network interface 106 (e.g., ETHERNET or WI-FI) for communication with a remote application or other devices/applications, a user interface 108 (e.g., a display/touchscreen, keyboard, mouse, or similar devices), and storage (e.g., flash memory or a solid-state or magnetic disk). The client 102 locally executes a web browser 110 running a remote web-based application 112. One of skill in the art will understand, however, that embodiments of the present invention are not limited to only the use of browser-based applications and that authentication using any locally executing remote application is within the scope of the current invention.

The client 102 further executes, in accordance with embodiments of the present invention, an authentication-request handler program 114 or program module. The authentication-request handler 114 may include software instructions written in C, C++, Java, or any other programming language and may be stored in non-volatile and/or volatile (e.g., RAM) storage and executed using the processor. The authentication-request handler 114 may run using a set of permissions and privileges stored on the client device 102 that allows it access to the user interface 106 and/or hardware-authentication device(s) 116; this set of permissions may correspond to user-level privileges, administrator or root privileges, or a custom set of privileges, and may be stored locally or downloaded from a remote server upon user log-on.

The authentication-request handler 114 may interact, via a wired or wireless interface, with one or more hardware-authentication device interfaces 118 within the request handler 114 or otherwise executing on the client device 102. A given hardware-authentication device 116 (e.g., a thumbprint reader, a palm reader, a retinal scanner, a smart-card or RFID reader, etc.) may require a specific set of software instructions and protocols in order to communicate with the client device 102; such instructions may take the form of a device driver, handshaking protocol, plug-and-play protocol, or similar instructions. In one embodiment, the hardware-authentication device 116 has an interface that includes all such software instructions necessary for this communication. In other embodiments, the hardware-authentication device interface 118 contains a portion of the software, and other software (such as device drivers or another executable program used to communicate with the hardware-authentication device 116) resides on the device 116. For example, a certain hardware-authentication device 116 may require the installation of a proprietary, closed-source device driver and communication program; the hardware-authentication device interface 118 may then communicate with the device driver and/or communication program via an API.

The authentication-request handler 114 may further include a login-window creator 120 for displaying a login window on the screen of the client device. The login window may be integrated with the window displaying the remote application 112 and may, if desired, use similar window decorations or may instead be a stand-alone window decorated by the operating system. The login-window creator 120 may disable and/or obscure some or all of the remote-application window (and/or other windows, or the entire desktop) while the user is being authenticated. Instead or in addition, a web server 122 (as explained in greater detail below) may host a web page that may be loaded as a subview of a page of the web-based application and that prompts for the username and password.

The authentication-request handler 114 may further include the web server 122. The web 122 server may be, for example, the APACHE web server provided by the APACHE SOFTWARE FOUNDATION, or any other similar server; it may, however, be modified to have a lower memory footprint or processor load requirement than a typical APACHE (or other) server by removing functionality not required by embodiments of the present invention. The web server 122 may be used to communicate with the web browser 110 and, specifically, the remote web-based application 112 executing via the browser. In one embodiment, when the web-based application 112 requires the user to be authenticated, it sends a message requesting authentication to the web server 122. The authentication-request handler 114 thereupon communicates with the hardware-authentication device interface 118 and/or login-window creator 120 to prompt for authentication information from the user. As mentioned above, the authentication information may be a username and password, a fingerprint, and/or other biometric information from the user.

Depending on the security policy implemented by the web-based application 112, the authentication request may specify one or more acceptable types of authentication information (e.g., password or fingerprint), in which case the web server 122 selects the most appropriate authentication modality from among those available on the client device. When more than one acceptable modality is available, the selection may, for example, be based on user convenience. In other embodiments, the authentication request may specify an authentication level rather than a type of authentication, and the web server 122 selects an authentication modality consistent with the specified level.

The present invention is not, however, limited to only web-based applications and web servers. In other embodiments, other remote applications use other types of mechanisms and software to provide a display window on a client device, such as the X WINDOW SYSTEM, CITRIX RECEIVER, MICROSOFT WINDOWS REMOTE DESKTOP, or any other such system or protocol. In these embodiments, a different communications program appropriate for a given protocol may be used in place of the web server.

When the authentication information is received, the user may be authenticated in any a variety of ways, all of which are within the scope of the present invention. In one embodiment, the authentication-request handler 114 sends the collected authentication information to the web-based application 112, which includes an authentication handler 124 and a database 126 of authentication information. For example, the password may be compared against a list of passwords associated with the user, or the fingerprint may be compared against a previously collected fingerprint of the user. The database 126 may be local or remote.

In another embodiment, an authentication server 130, such as the ONESIGN server provided by Imprivata, Inc., Lexington, MA, may be used to authenticate the user by comparing the received information against a database 132 of authentication information; once again, the database 132 may be local or remote to the authentication server 130. The authentication information may be sent to the authentication server 130 directly from the authentication-request handler 114 or indirectly via the web-based application 112. The authentication server 130 may execute on a separate remote or local device or server or may execute on the client device 102. In one embodiment, a given network or site shares a single (or low number) of authentication servers 130 with a plurality of client devices 102.

In one embodiment, the web-based application 112 includes an authentication-interface script 134 for facilitating communication with the web server 122. The script 134 may be stored in volatile or nonvolatile memory and include commands or functions for sending a request for authentication to the web server 122, for querying the web server 122 regarding the status of an authentication attempt, for forwarding the request to the authentication server 130, or for sending information regarding the user, type or name of the web-based application 112, time of authentication attempt, or other such information to the web server 122 or authentication server 130. In one embodiment, the script 134 is a JAVASCRIPT library or JAR file and may be included in one or more web pages displayed using the web-based application 112. The script 134 may include a function named SendAuthenticationRequest<user>,<IP>), for example, where <user>is the name or username of the user and <IP>is the IP address of the web server. When authentication is required, the web-based application 112 may call this function with the appropriate parameters. The web server 122 may monitor requests on an incoming IP address or port; the requests may be HTTP or HTTPS requests or other similar types of requests.

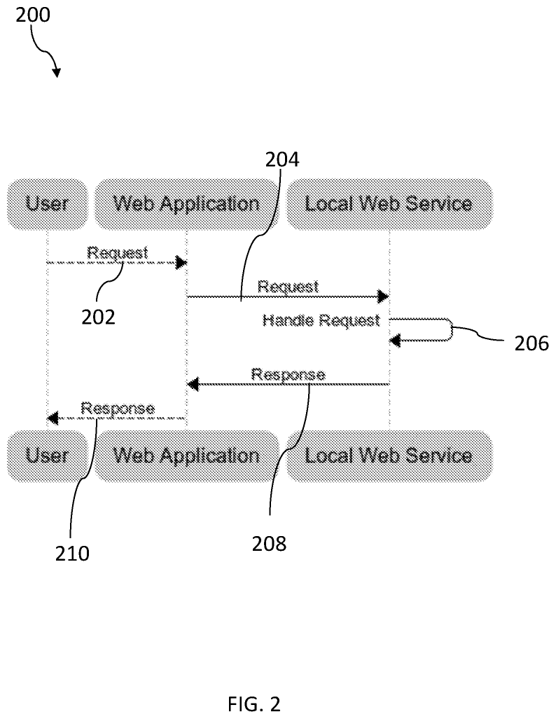

FIG. 2 illustrates an exemplary workflow 200 in accordance with embodiments of the present invention. In a first step 202, a user requests authentication from the web-based application; this request may be, for example, a request to authenticate the user with a fingerprint. Alternatively, as mentioned above, the web-based application or authentication server may initiate the request. In a second step 204, the web-based application sends a service request to the web server requesting that it perform the authentication. In a third step 206, the web server services the request by, for example, displaying a username/login screen and/or calling the appropriate native code to interact with a hardware authentication device. When the username and password have been entered and/or the device has completed the action, in a fourth step 208, the web server responds to the web-based application by sending the collected information (e.g., a captured fingerprint). In a fifth step 210, the web-based application verifies the identity of the user using the received information. The response in step 210 may include or trigger programming of a token for the user as described in greater detail below.

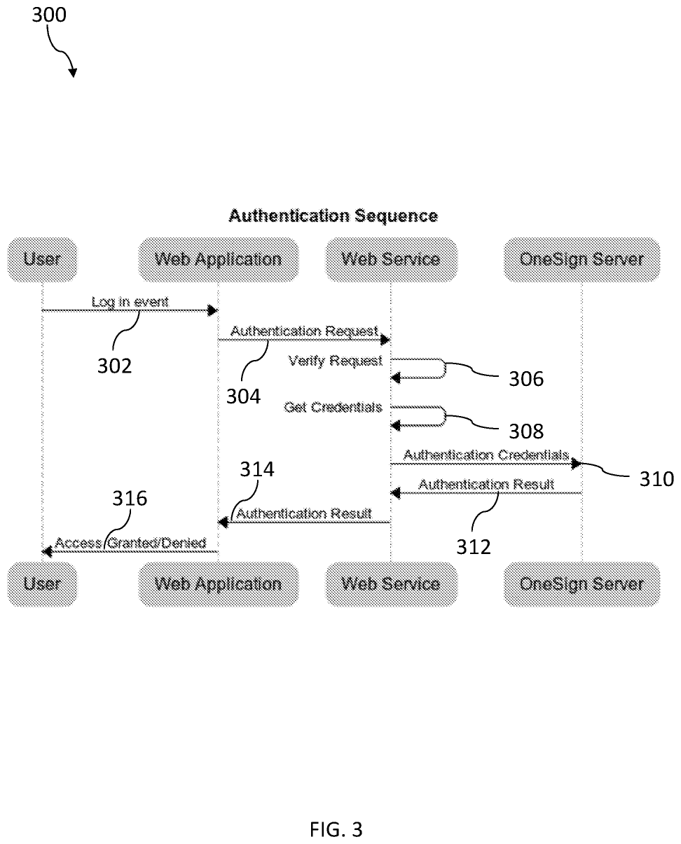

Another exemplary workflow 300 appears in FIG. 3. In this example, an authentication server is used to authenticate the user. Instead of the web-based application performing the authentication, it forwards the log-in information received from the user in step 302 to the web server (step 304). The web-based application sends a service request to the web server requesting that it verify the request (step 306) and obtain authentication credentials (step 308), and thereupon transmit the credentials to the authentication (e.g., ONESIGN) server (step 310). Once the user is authenticated by the authentication server, the authentication server sends an indication or acknowledgment thereof back to the web server (step 312) for handling by the web- based application (step 314). As mentioned above, the authentication server may be used to authenticate a plurality of users in a plurality of web-based applications. Upon positive authentication, the web-based application may grant access to the user and, in various embodiments, program a token for the user or launch a separate process for doing so (step 316).

With reference to FIGS. 1-3, a token programmer 140 may be responsive to the authentication-request handler 114 (or other running process) via the network interface 108 to create a token for the user upon his or her successful authentication (e.g., in conjunction with or after steps 210 or 316). The authentication-request handler 114 may, for example, communicate with the authentication server 130 or consult a local database to determine the authentication token(s) the user should possess and whether all have, in fact, been issued to the user. If not, the authentication-request handler 114 may operate an internal or (more typically) external token programmer 140 to create the token(s), sparing the user from having to complete a separate registration process. Since the user has already successfully authenticated himself or herself via authentication-request handler 114, the token programmer 140 may issue one or more tokens to the user without requiring any additional authentication information from the user. In this manner, embodiments of the present invention provision tokens users to enable their access to secure resources after the users have been authenticated in conjunction with another unrelated application or resource, thereby enhancing the efficiency and convenience of affording user access to multiple different secure resources.

As used herein, the term “token” connotes an authentication modality such as a smart card, RFID tag, digital signature, key, or similar secure credential that is associated with the user and serves to authenticate the user in accordance with an institutional security policy. The token may be a dedicated physical device (a smart card, RFID tag, dongle, etc.) that the user carries with him, or may instead be an encrypted data file (e.g., an epf file) stored on the user's mobile device, such as a smart phone or tablet; such tokens are herein referred to as “soft tokens.” In the former case, the token is typically presented to a dedicated reader device (e.g., a perimeter-access reader) for physical access, while in the latter case, it may be presented to a secure resource (such as, for example, the client device 102) via wireless communication — e.g., near-field communication (NFC), point-to-point Bluetooth, or cell-phone communication — for electronic access. Whether the token will be adequate to gain physical or electronic access to a particular secure resource will depend on the applicable security policy.

Where the token is a physical device, the user may be prompted to obtain and present an unprogrammed token—or a previously programmed token that has expired or will soon—to the token programmer 140. Otherwise, the user may be prompted to launch an application on a mobile device that will wirelessly handshake with the token programmer 140 (e.g., via NFC or Bluetooth) to receive and store the token. In the latter case, the token programmer may be a running process within the client device 102 that communicates externally via the network interface 108. A secure embedded data token may include identifying information for the user encrypted in accordance with an institutional protocol. When the user presents the token to a reader or resource, the latter decrypts the token, determines the user's identity, and verifies (i) that the user has an adequate privilege level for access to the resource and (ii) that the token represents an acceptable modality for access. If the resource requires a stronger form of authentication, the user may be prompted for, e.g., a thumbprint or password.

For example, the authentication server may include a policy handler 150 for implementing security policies for users or applications. The policy handler 150 may implement a rule base specifying resources and privilege levels and permissions associated with the resources, as well as a database storing the privilege levels associated with various users. In a simple scenario, the policy handler 150 specifies that all users are required to enter their usernames and passwords upon booting a web-based application. The policy handler 150 may vary the policy for different users, however, depending on privilege level: certain users may be required to also authenticate using a hardware device or at more frequent times, for example. Similarly, the policy handler 150 may specify that certain applications require different authentication procedures or frequencies. The policy handler 150 may further allow different levels of authentication for the same user using the same application; if, for example, a user has already been authenticated using a more-stringent form of authentication (username, password, and fingerprint, for example), a subsequent authentication for that application (or other applications for which authentication information has not yet been acquired from the user) may require a less-stringent form (a token, for example) if less than a certain amount of time has passed since the first login (one hour, perhaps) or if the user's presence within the facility where the client is located has been verified by other means (e.g., an access-control system).

In some embodiments, expiration of a user's previous authorization to use an application may be triggered if the session goes idle or if the user walks away. In some examples, a token is providable by the user to access one or more secure resources other than a remote application in a subsequent authorization, in conjunction with the one or more secure resources, after expiration of the user's authorization to use the remote application.

In various embodiments of the present invention, authentication requests, authentication grants, or authentication information may be verified upon receipt by the web server 122, web-based application 112, and/or authentication server 130. For example, when the web server 122 receives an authentication request from the web-based application 112, it may verify that it originated from a valid source by, e.g., verifying that the request was generated on the client device 102, verifying that the request includes a supported vendor ID, and/or verifying that the request is signed by a particular key.

The web server may be used by the web-based application to communicate with other peripherals of the client device than the hardware-based authentication devices, particularly other peripherals that would otherwise require the use of a browser plug-in. Authentication of the user may or may not first be required before use of these other peripherals. The use of a webcam by a web-based application, for example, typically requires the use of a webcam plug-in; instead, the web-based application 112 may access the webcam via the web server 122, which may then communicate with the webcam. In this embodiment, in addition to the transmitting of authentication requests and information, the web server may also transmit or stream data (e.g., video data).

Instead or in addition, the web server may be used by the web-based application to access peripherals even if they would not otherwise require a browser plug-in, such as (for example) printers, scanners, or faxes. In these embodiments, the web-based application 112 is able to access these otherwise-available peripherals only if the user is authenticated and/or if the user approves, thus providing a layer of security between the web-based application 112 and the peripherals that would otherwise be missing.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for enabling user access to secure resources in conjunction with authentication of the user on a client device executing a remote application, the system comprising:
a database of authentication data;
a database of authorization information;
a client device comprising:
i. a network interface;
ii. a computer processor for executing software instructions of a remote application;
iii. an authorization-request handler, executable by the computer processor, configured to:
a. electronically receive a request to authenticate the user from the remote application, the remote application being an application other than a token programmer,
b. prompt the user for authentication information in a manner consistent with the request,
c. communicate with a hardware device in electronic communication with the client device to obtain the authentication information, and
d. cause the authentication information to be compared to authentication data in the database of authentication data to verify that the user is authorized to use the remote application; and
iv. a token-generation module, executable by the computer processor, configured to, only after the user is authorized to use the remote application, and before any attempt to access by the user, or any access of by the user, any secure resources other than the remote application:
A. automatically electronically receive, from the database of authorization information, authorization information for the user related to one or more secure resources other than the remote application, and
B. automatically cause a token programmer to program a token for the user consistent with the authorization information without requiring additional authentication of the user by the token programmer and without receiving additional authentication information from the user, the token being (i) providable by the user to access the one or more secure resources other than the remote application, (ii) distinct from the authentication information obtained by the authorization-request handler, and (iii) not based on authentication information received from the user,
wherein the token is providable by the user to access the one or more secure resources other than the remote application in a subsequent authorization, in conjunction with the one or more secure resources, after expiration of the user's authorization to use the remote application.

2. The system of claim 1, further comprising a remote host for hosting the remote application and comparing the authentication information to the database of authentication data.

3. The system of claim 1, further comprising an authorization server for comparing the authentication information to the database of authentication data, wherein the authorization server does not host the remote application.

4. The system of claim 1, wherein the token programmer is configured to program at least one of a smart card, RFID tag, or soft token.

5. The system of claim 1, wherein the authorization information specifies physical access restrictions for the user.

6. The system of claim 1, wherein the authorization information specifies electronic access restrictions for the user.

7. The system of claim 1, further comprising an authorization server for managing the database of authorization information and returning user information therefrom in response to a request from the client.

8. The system of claim 1, wherein the token is providable by the user to access the one or more secure resources other than the remote application without use of the client device.

9. The system of claim 1, wherein the token-generation module is configured to cause the token generator to program the token for the user only after the user presents an unprogrammed or previously programmed token to the token generator.

10. The system of claim 1, wherein the token-generation module is configured to cause the token generator to program the token for the user only after the user launches an application on a mobile device to wirelessly connect to the token generator for receipt of the token therefrom.

11. The system of claim 10, wherein the mobile device is different from the client device.

12. The system of claim 1, wherein the token-generation module is configured to cause the token generator to store the token on a mobile device of the user.

13. The system of claim 12, wherein the mobile device is different from the client device.

14. The system of claim 1, wherein the token is providable by the user to access the one or more secure resources other than the remote application only in conjunction with additional authentication information provided by the user.

15. The system of claim 14, wherein the additional authentication information comprises a password or biometric information.

16. The system of claim 1, wherein the token is a dedicated physical device configured to be carried by the user.

17. The system of claim 1, further comprising a policy handler configured to, automatically, after the user is authorized to use the remote application and before any attempt to access and before any access by the user of any secure resources other than the remote application, determine the one or more secure resources for which the token programmer is caused to program the token.

18. The system of claim 17, wherein the policy handler is configured to implement (i) a rule base specifying the secure resources and privilege levels and permissions associated therewith, and (ii) a database associating the privilege levels associated with a plurality of users, the policy handler being configured to determine the one or more secure resources for which the token programmer is caused to program the token based at least on the rule base and the database.

19. The system of claim 1, wherein the token is not usable to access the remote application.

20. A method for authenticating a user of a client device executing a remote application, and, in conjunction therewith, enabling access for the user to secure resources, the method comprising:
electronically receiving, from the remote application, with an authentication-request handler local to the client device, an HTTP or HTTPS request to authenticate the user, the remote application being an application other than a token programmer;
prompting the user for authentication information;
with the handler, communicating with a hardware device in electronic communication with the client device to obtain the authentication information;
verifying, using a computer processor and the authentication information, that the user is authorized to use the remote application; and
only after the user is authorized to use the remote application, and before any attempt to access by the user, or any access of by the user, any secure resources other than the remote application, (A) automatically receiving authorization information for the user related to one or more secure resources other than the remote application from a database of authorization information, and (B) thereafter, automatically causing a token to be programmed for the user consistent with the authorization information without requiring additional authentication of the user and without receiving additional authentication information from the user, the token being (i) providable by the user to access the one or more secure resources other than the remote application, (ii) distinct from the authentication information obtained by the authorization-request handler, and (iii) not based on authentication information received from the user, wherein the token is providable by the user to access the one or more secure resources other than the remote application in a subsequent authorization, in conjunction with the one or more secure resources, after expiration of the user's authorization to use the remote application.

21. The method of claim 20, wherein the step of verifying is performed by the remote application.

22. The method of claim 20, wherein the step of verifying is performed by an authorization server and further comprising electronically sending, to the remote application, an HTTP or HTTPS message confirming authentication of the user.

23. The method of claim 20, wherein the token is a smart card, RFID tag, or soft token.

24. The method of claim 20, wherein the authorization information specifies physical access restrictions for the user.

25. The method of claim 20, wherein the authorization information specifies electronic access restrictions for the user.

26. The method of claim 20, further comprising, without any attempt to access and without any access of any secure resources other than the remote application by the user, and before the authorization information is received and before the token is programmed, automatically determining, with a policy handler, the one or more secure resources for which the token programmer is automatically caused to program the token.

27. The method of claim 26, wherein the policy handler is configured to implement (i) a rule base specifying the secure resources and privilege levels and permissions associated therewith, and (ii) a database associating the privilege levels associated with a plurality of users, the policy handler being configured to determine the one or more secure resources for which the token programmer is caused to program the token based at least on the rule base and the database.

28. The method of claim 20, wherein the token is not usable to access the remote application.
